(19) United States
(12) Patent Application Publication
(10) Pub. No.: US 2021/0079923 A1
(43) Pub. Date: Mar. 18, 2021

(54) ELECTRIC BLOWER

(71) Applicant: DENSO CORPORATION, Kariya-city (JP)

(72) Inventors: Takashi KUSADA, Nisshin-city (JP); Tsukasa OHZAWA, Kariya-city (JP); Sotaro SAITO, Kariya-city (JP)

(21) Appl. No.: 17/103,114

(22) Filed: Nov. 24, 2020

Related U.S. Application Data
(63) Continuation of application No. PCT/JP2019/020443, filed on May 23, 2019.

(30) Foreign Application Priority Data
May 29, 2018 (JP) 2018-102730

(51) Int. Cl. F04D 25/08; F04D 29/42; F04D 29/66

(52) U.S. Cl. CPC F04D 25/08; F04D 29/668; F04D 29/4213; F04D 29/4226

(57) ABSTRACT

An electric blower includes a fan, an electric motor, a motor holder, and a fan casing. The fan casing includes a facing wall and the motor holder includes an extending portion overlapping with the facing wall in an axial direction. The facing wall and the extending portion include attachment portions that connect the motor holder to the fan casing and non-attachment portions between the attachment portions. Either one of the facing portion and the extending portion includes an annular protrusion. The other includes an annular fitting recess into which the annular protrusion is fit. A contacting load is defined by a load applied to the annular protrusion and the annular fitting recess in the axial direction or an intersecting direction intersecting the axial direction. At least one of the non-attachment portions receives the contacting load that is greater than the contacting load applied to each of the attachment portions.

### CROSS REFERENCE TO RELATED APPLICATIONS

The present application is a continuation application of International Patent Application No. PCT/JP2019/020443 filed on May 23, 2019, which designated the U.S. and claims the benefit of priority from Japanese Patent Application No. 2018-102730 filed on May 29, 2018. The entire disclosures of all of the above applications are incorporated herein by reference.

### TECHNICAL FIELD

The present disclosure relates to an electric blower.

### BACKGROUND ART

Various noise reduction structures for reducing magnetic noise generated by an electric motor of an electric blower have been proposed. The electric blower includes a motor holder for holding the electric motor. The motor holder has a tubular portion housing the electric motor. A torsional rigidity of the tubular portion is locally reduced to damp vibrations transmitted from the electric motor to a fan casing.

### SUMMARY

An electric blower includes a fan, an electric motor, a motor holder, and a fan casing. The fan is configured to generate an airflow by rotating about a rotational axis. The electric motor is configured to rotate the fan. The motor holder supports the electric motor. The fan casing houses the fan, includes a facing wall that faces an air suction opening, and defines an insertion hole. An air is introduced into the fan casing through the air suction opening. A part of the motor holder is inserted into the insertion hole.

The motor holder includes a motor housing that has a tubular shape and houses the electric motor and an extending portion that has an annular shape, surrounds the motor housing, and overlaps with the facing wall in an axial direction along the rotational axis. The facing wall and the extending portion include multiple attachment portions that connect the motor holder to the fan casing in a state where the motor housing is inserted into the insertion hole. The multiple attachment portions are arranged in a circumferential direction of the motor housing at predetermined intervals. The facing wall and the extending portion include multiple non-attachment portions between the attachment portions in the circumferential direction. Either one of the extending portion and the facing wall includes an annular protrusion protruding toward the other of the extending portion and the facing wall. The other of the extending portion and the facing wall includes an annular fitting recess into which the annular protrusion is fit when the motor holder is connected to the fan casing. A contacting load is defined by a load applied to the annular protrusion and the annular fitting recess in the axial direction or an intersecting direction intersecting the axial direction in a state where the motor holder is connected to the fan casing by the attachment portions. The annular protrusion and the annular fitting recess are configured such that at least one of the non-attachment portions receives the contacting load that is greater than the contacting load applied to each of the attachment portions.

### BRIEF DESCRIPTION OF DRAWINGS

FIG. 1 is an exploded perspective view of an electric blower in a first embodiment.

FIG. 2 is a schematic cross-sectional view of the electric blower in the first embodiment.

FIG. 3 is a schematic cross-sectional view of a fan casing of the electric blower in the first embodiment.

FIG. 4 is a schematic view of the fan casing viewed in a direction of an arrow IV in FIG. 3.

FIG. 5 is a schematic cross-sectional view of a motor holder of the electric blower in the first embodiment.

FIG. 6 is a schematic view of the motor holder viewed in a direction of an arrow VI in FIG. 5.

FIG. 7 is a cross-sectional view taken along a line VII-VII in FIG. 6.

FIG. 8 is a schematic view illustrating a connecting structure between the motor holder and the fan casing of the electric blower in the first embodiment.

FIG. 9 is a schematic view illustrating a contacting load applied to an annular protrusion and an annular fitting recess of an electric motor in a comparative example of the first embodiment.

FIG. 10 is a schematic view illustrating a contacting load applied to an annular protrusion and an annular fitting recess of the electric motor in the first embodiment.

FIG. 11 is a graph illustrating a restricting effect for vibrations in the electric blower in the first embodiment.

FIG. 12 is a graph illustrating a restriction effect for noises in the electric blower in the first embodiment.

FIG. 13 is a cross-sectional view corresponding to FIG. 7 and illustrating a shape of the annular fitting recess.

FIG. 14 is a schematic cross-sectional view of a fan casing of an electric blower in a second embodiment.

FIG. 15 is a schematic cross sectional view of a motor holder of the electric blower in the second embodiment.

FIG. 16 is a schematic view illustrating a connecting structure between the motor holder and the fan casing of the electric blower in the second embodiment.

FIG. 17 is a schematic cross-sectional view of a motor holder of an electric blower in a third embodiment.

FIG. 18 is a schematic view of the motor holder viewed in a direction of an arrow XVIII in FIG. 17.

FIG. 19 is a cross-sectional view taken along a line XIX-XIX in FIG. 18.

FIG. 20 is a schematic view illustrating a connecting structure between the motor holder and the fan casing of the electric blower in the third embodiment.

FIG. 21 is a schematic cross-sectional view of a motor holder of an electric blower in a fourth embodiment.

FIG. 22 is a schematic view illustrating a connecting structure between the motor holder and the fan casing of the electric blower in the fourth embodiment.

FIG. 23 is a schematic cross-sectional view of an electric blower in a fifth embodiment.

FIG. 24 is a schematic cross-sectional view of a fan casing of the electric blower in the fifth embodiment.

FIG. 25 is a schematic cross-sectional view of a motor holder of the electric blower in the fifth embodiment.

FIG. 26 is a schematic cross-sectional view illustrating a connecting structure between the motor holder and the fan casing of the electric blower in the fifth embodiment.

### DESCRIPTION OF EMBODIMENTS

To begin with, examples of relevant techniques will be described.

Various noise reduction structures for reducing magnetic noise generated by an electric motor of an electric blower have been proposed. The electric blower includes a motor holder for holding the electric motor. The motor holder has a tubular portion housing the electric motor. A torsional rigidity of the tubular portion is locally reduced to damp vibrations transmitted from the electric motor to a fan casing.

The electric blower includes a supporter connected to the tubular portion of the motor holder and multiple attachment portions at the supporter. The motor holder is connected to the fan casing with the multiple attachment portions. The inventors of the present disclosure study the electric motor having such connecting structure between the motor holder and the fan casing and found that non-attachment portions located between the multiple attachment portions greatly vibrated using the multiple attachment portions as nodes when the vibrations of the electric motor were transmitted to the fan casing through the motor holder. Such vibrations are not preferable since the vibrations increase a noise caused by magnetic noise.

It is objective of the present disclosure to provide an electric blower that can reduce a noise.

According to an aspect of the present disclosure, an electric blower includes a fan, an electric motor, a motor holder, and a fan casing. The fan is configured to generate an airflow by rotating about a rotational axis. The electric motor is configured to rotate the fan. The motor holder supports the electric motor. The fan casing houses the fan, includes a facing wall that faces an air suction opening, and defines an insertion hole. An air is introduced into the fan casing through the air suction opening. A part of the motor holder is inserted into the insertion hole.

The motor holder includes a motor housing that has a tubular shape and houses the electric motor and an extending portion that has an annular shape, surrounds the motor housing, and overlaps with the facing wall in an axial direction along the rotational axis. The facing wall and the extending portion include multiple attachment portions that connect the motor holder to the fan casing in a state where the motor housing is inserted into the insertion hole. The multiple attachment portions are arranged in a circumferential direction of the motor housing at predetermined intervals. The facing wall and the extending portion include multiple non-attachment portions between the attachment portions in the circumferential direction. Either one of the extending portion and the facing wall includes an annular protrusion protruding toward the other of the extending portion and the facing wall. The other of the extending portion and the facing wall includes an annular fitting recess into which the annular protrusion is fit when the motor holder is connected to the fan casing. A contacting load is defined by a load applied to the annular protrusion and the annular fitting recess in the axial direction or an intersecting direction intersecting the axial direction in a state where the motor holder is connected to the fan casing by the attachment portions. The annular protrusion and the annular fitting recess are configured such that at least one of the non-attachment portions receives the contacting load that is greater than the contacting load applied to each of the attachment portions.

As described above, the annular protrusion and the annular fitting recess have parts located in the non-attachment portions that receive the contacting load greater than the contacting load applied to the attachment portions, so that a contacting state between the annular protrusion and the annular fitting recess in the non-attachment portions are more likely to be kept even when operating the electric motor. Thus, the non-attachment portions are less likely to vibrate and a noise caused by vibrations of the non-attachment portions can be reduced. Thus, the electric blower can reduce the noise.

Embodiments of the present disclosure will be described below with reference to the drawings. In the following embodiments, portions that are the same as or equivalent to those described in the preceding embodiments are denoted by the same reference numerals, and a description of the same or equivalent portions may be omitted. In addition, when only a part of the components is described in the embodiment, the components described in the preceding embodiment can be applied to other parts of the components. In the following embodiments, the embodiments can be partially combined with each other as long as the embodiments do not cause any trouble in combination, even if the combination is not specified in particular.

### First Embodiment

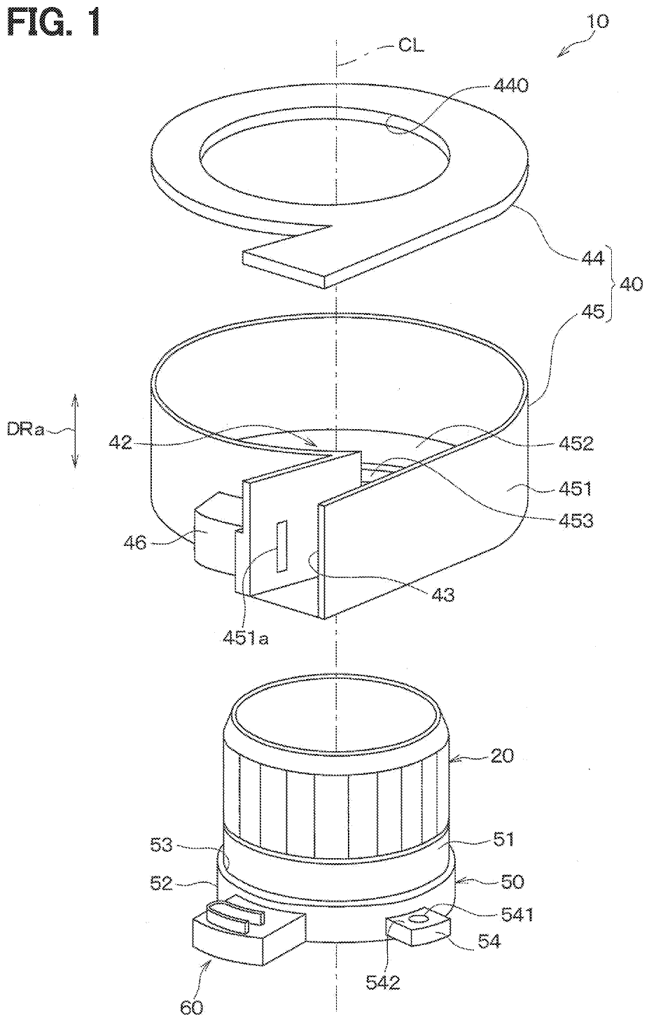

The present disclosure will be described with reference to FIGS. 1 to 12. In this embodiment, an electric blower 10 is applied for a blower unit of an air conditioner configured to condition an air in a vehicle cabin. The electric blower 10 is disposed inside an instrument panel located in a front side of the vehicle cabin.

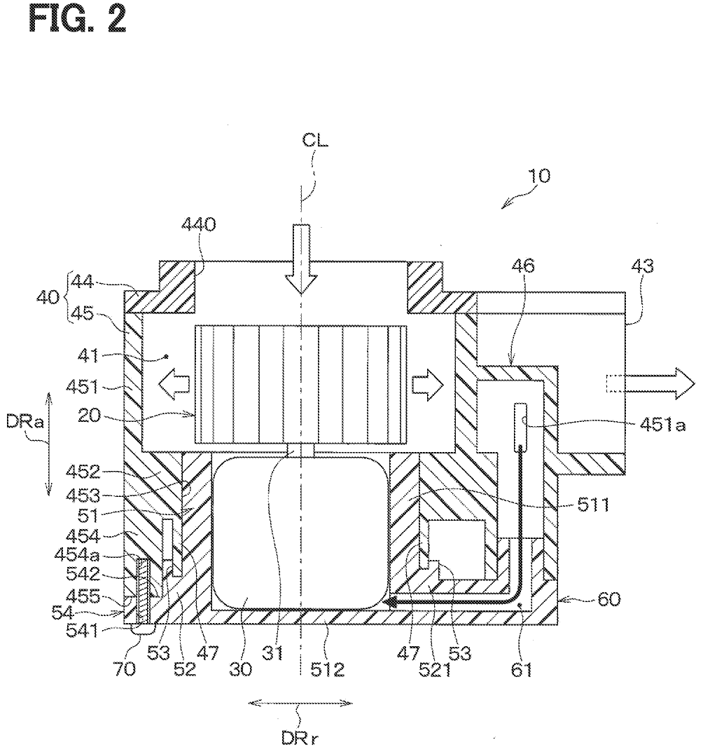

As shown in FIGS. 1 and 2, the electric blower 10 includes a fan 20 configured to generate an airflow, an electric motor 30 configured to rotate the fan 20, a fan casing 40 housing the fan 20, and a motor holder 50 holding the electric motor 30.

The fan 20 is a centrifugal fan that suctions an air along a rotational axis CL shown in FIG. 2 and blows the sucked air in an intersecting direction intersecting with the rotational axis CL. The fan 20 is made of, for example, a resin. The fan 20 is connected to a rotational shaft 31 of the electric motor 30 through a connecting portion (not shown).

The rotational axis CL of the fan 20 is an axis that is a rotational center of the fan 20. In this embodiment, a direction extending along the rotational axis CL of the fan 20 is referred to as an axial direction DRa and a direction perpendicular to the rotational axis CL of the fan 20 is referred to as a radial direction DRr. The radial direction DRr is an intersecting direction intersecting the axial direction DRa of the fan 20.

The electric motor 30 is an electric device configured to rotate the fan 20 by rotating the rotational shaft 31. The electric motor 30 is configured with, for example, an inner rotor type brushless motor. The electric motor 30 includes a tubular housing made of a metal, a stator fixed to an inside of the tubular housing, and a rotor including a permanent magnet and fixed to the rotational shaft although they are not shown. The rotational shaft 31 is supported rotatable at the housing by a bearing disposed in the housing.

The fan casing 40 is a casing housing the fan 20. The fan casing 40 is made of, for example, a resin member. The fan casing 40 is constituted as a scroll casing that forms a ventilation passage 41 having a spiral shape through which an air circulates in an outer circumferential side of the fan 20.

The fan casing 40 includes a nose portion 42 that defines a start of scrolling of the ventilation passage 41 having a spiral shape. The ventilation passage 41 has an upstream end in an airflow direction in communication with a downstream end of the ventilation passage 41 in the airflow direction through a slight space in a vicinity of the nose portion 42.

The fan casing 40 defines an air blowing outlet 43 at a position in the most downstream side of the ventilation passage 41 in the airflow direction. The air blown out by the fan 20 flows through the ventilation passage 41 and is blown out through the air blowing outlet 43.

Specifically, the fan casing 40 includes a bell mouth plate 44 having a plate shape and a cup-shaped body 45 connected to the bell mouth plate 44 to define the ventilation passage 41 together with the bell mouth plate 44. The fan casing 40 is configured such that the bell mouth plate 44 is fastened to the cup-shaped body 45 with a fastening member such as a snap fit and a screw.

The bell mouth plate 44 forms an upper lid of the fan casing 40. The bell mouth plate 44 defines an air suction opening 440 opening into a circle about the rotational axis CL of the fan 20. The air suction opening 440 is an opening through which the air is sucked into the fan 20.

The cup-shaped body 45 includes an outer circumferential wall 451 surrounding the fan 20 and a bottom wall 452 connected to the outer circumferential wall 451 and facing the bell mouth plate 44 in the axial direction DRa through the fan 20.

The outer circumferential wall 451 forms a side surface of the fan casing 40. The outer circumferential wall 451 is formed into a spiral shape such that a length between the rotational axis CL and a part of an inner surface of the outer circumferential wall 451 increases according to a known logarithmic spiral function. The outer circumferential wall 451 includes a duct receiving portion 46 at a position outside of the nose portion 42 in the radial direction DRr. The duct receiving portion 46 is configured to receive a duct 60 which will be described later. The outer circumferential wall 451 defines a communication hole 451a through which a part of the air flowing through the ventilation passage 41 flows into the duct receiving portion 46. The communication hole 451a is defined at a position of the outer circumferential wall 451 in a vicinity of the duct receiving portion 46.

The duct receiving portion 46 surrounds the nose portion 42. The duct receiving portion 46 has a hollow shape to receive the duct 60 which will be described later.

The bottom wall 452 forms a bottom surface of the fan casing 40. The bottom wall 452 defines an insertion hole 453 opening into a circle about the rotational axis CL of the fan 20. The insertion hole 453 is an opening through which a part of the motor holder 50 is inserted into the fan casing 40. The insertion hole 453 has a size such that at least a part of the motor holder 50 can be inserted into the insertion hole 453. In this embodiment, the bottom wall 452 constitutes a facing wall of the fan casing 40 that faces the air suction opening 440.

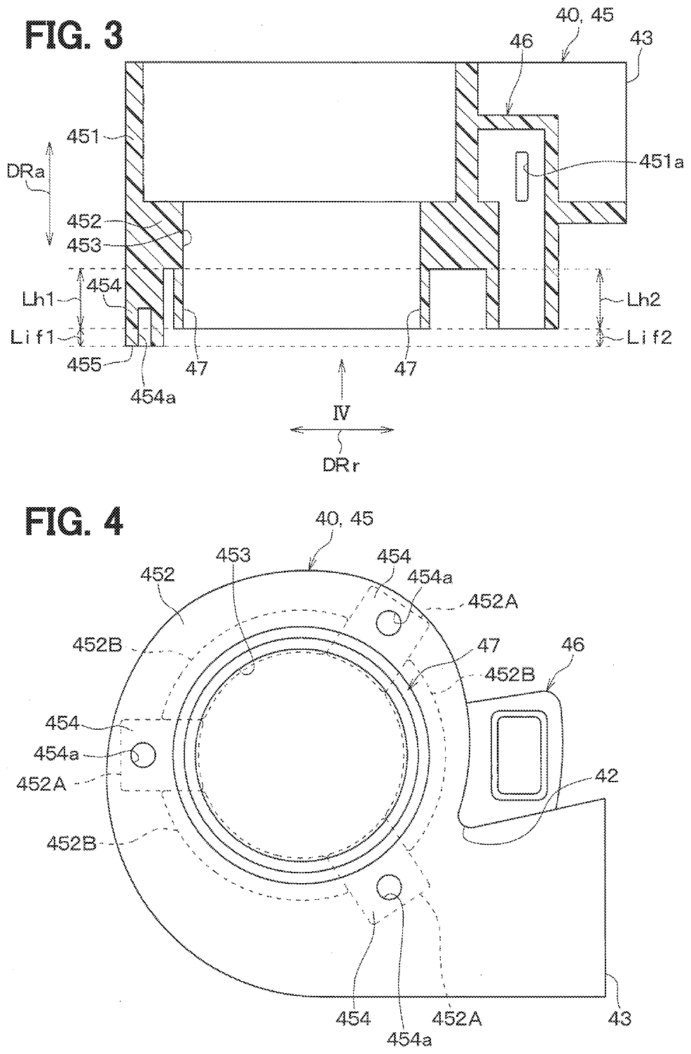

As shown in FIGS. 3 and 4, the bottom wall 452 includes an annular protrusion 47 in a circumferential edge that defines the insertion hole 453. The annular protrusion 47 has an annular shape. The annular protrusion 47 is integrally formed with the bottom wall 452. The annular protrusion 47 protrudes toward an extending portion 52 of the motor holder 50 which will be described later.

The bottom wall 452 includes multiple supporters 454 that supports the motor holder 50, which will be described later, in an outside of the annular protrusion 47 in the radial direction DRr. The supporters 454 protrude toward a holder flange 54 which will be described later.

The supporters 454 define multiple attachment holes 454a in portions of the supporters 454 that faces the holder flange 54. The number of the attachment holes 454a in this embodiment is three and the three attachment holes 454a are arranged around the insertion hole 453 at predetermined intervals. Each of the attachment holes 454a includes a thread of a female screw corresponding to a fastening bolt 70 which will be described later. The supporters 454 have attachment end surfaces 455 on which the attachment holes 454a opens and the attachment end surfaces 455 are in contact with the motor holder 50 when the motor holder 50 is connected to the fan casing 40.

In this embodiment, as shown in FIG. 4, portions of the bottom wall 452 in a vicinity of the multiple attachment holes 454a forms multiple attachment portions of the fan casing 40 to which the motor holder 50 is connected. The attachment portions includes a facing region of the bottom wall 452 that overlaps with the holder flange 54 which will be described later and an inner region located radially inward of the facing region. In this embodiment, portions of the bottom wall 452 between the attachment portions in a circumferential direction of the fan casing 40 form non-attachment portions. To distinguish the attachment portions and the non-attachment portions of the fan casing 40 from those of the motor holder 50, the attachment portions of the fan casing 40 are referred to as first attachment portions 452A and the non-attachment portions of the fan casing 40 are referred to as first non-attachment portions 452B.

The annular protrusion 47 has a height Lh in the axial direction DRa and the height Lh is constant in the circumferential direction. That is, the annular protrusion 47 in this embodiment is formed such that heights Lh1 of parts of the annular protrusion 47 located in the first attachment portions 452A are same as heights Lh2 of parts of the annular protrusion 47 located in the first non-attachment portions 452B.

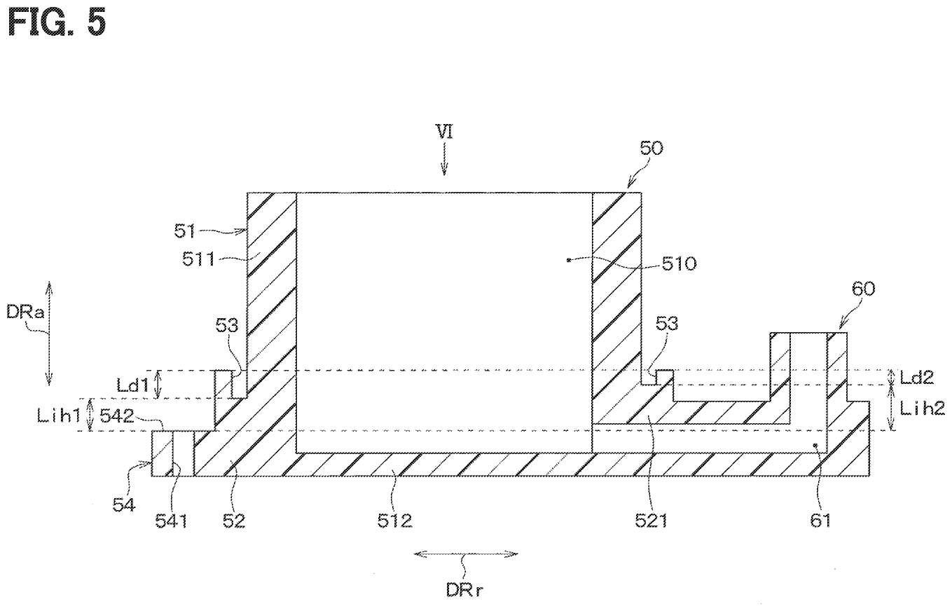

Next, the motor holder 50 will be described with reference to FIGS. 5 to 7. The motor holder 50 holds the electric motor 30. The motor holder 50 is made of, for example, a resin.

As shown in FIG. 5, the motor holder 50 includes a motor housing 51 and the extending portion 52. The motor housing 51 has a tubular shape and the electric motor 30 is housed in the motor housing 51. The extending portion 52 has an annular shape, surrounds the motor housing 51, and overlaps with the bottom wall 452 of the fan casing 40 in the axial direction DRa.

The motor housing 51 defines a housing space 510 in which the electric motor 30 is housed. The motor housing 51 has a bottomed tubular shape to house the electric motor 30. Specifically, the motor housing 51 includes a tubular portion 511 having a substantial cylindrical hollow shape and a bottom portion 512 forming a bottom of the motor housing 51. The tubular portion 511 forms an outer circumferential portion of the motor housing 51 and has an end opening closed by the bottom portion 512.

The extending portion 52 is formed into an annular shape to surround the motor housing 51 and protrudes outward from the tubular portion 511 in the radial direction DRr. The extending portion 52 defines an annular fitting recess 53 having an annular shape. The annular protrusion 47 is fit into the annular fitting recess 53 when the motor holder 50 is connected to the fan casing 40.

The extending portion 52 includes multiple holder flanges 54 protruding radially outward. The number of the holder flanges 54 in this embodiment is three and the three holder flanges 54 are arranged in the circumferential direction of the motor housing 51 at predetermined intervals. Each of the holder flanges 54 defines a bolt insertion hole 541 into which the fastening bolt 70 is inserted. The holder flanges 54 have facing end surfaces 542 that overlaps with the bottom wall 452 in the axial direction DRa and the facing end surfaces 542 serves as mating surfaces that are in contact with the fan casing 40 when the motor holder 50 is connected to the fan casing 40.

In addition, the extending portion 52 includes the duct 60 that extends outward in the intersecting direction intersecting the axial direction DRa. A part of the air flowing through the ventilation passage 41 is guided into the motor housing 51 as a cooling air through the duct 60. In this embodiment, a portion of the extending portion 52 connected to the duct 60 serves as a duct connecting portion 521.

The duct 60 has a tubular shape to define therein a cooling air passage 61 through which the cooling air flows. The duct 60 is connected to a portion of the extending portion 52 outside of the holder flanges 54 not to interfere with the holder flanges 54. The duct 60 has an upstream end in a flow direction of the cooling air that fits into the duct receiving portion 46 of the fan casing 40.

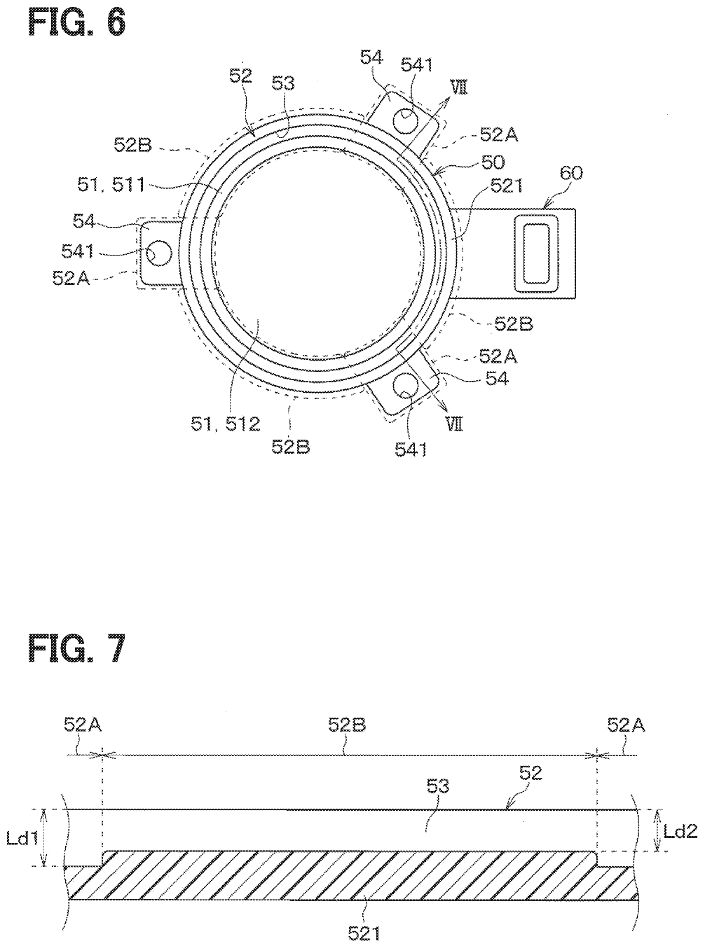

As shown in FIG. 6, in this embodiment, portions of the extending portion 52 in a vicinity of the multiple holder flanges 54 constitute the multiple attachment portions of the motor holder 50 to which the fan casing 40 is attached. The attachment portions include a region occupied by the holder flanges 54 and an inner region in the radial direction DRr of the region occupied by the holder flanges 54. In this embodiment, portions of the extending portion 52 between the attachment portions in the circumferential direction constitute non-attachment portions. To distinguish the attachment portions and the non-attachment portions of the motor holder 50 from those of the fan casing 40, the attachment portions of the motor holder 50 are referred to as second attachment portions 52A and the non-attachment portions of the motor holder 50 are referred to as second non-attachment portions 52B. The second non-attachment portions 52B include the duct connecting portion 521.

The annular fitting recess 52 has a depth Ld in the axial direction DRa such that a tip end of the annular protrusion 47 is in contact with a bottom surface of the annular fitting recess 53 when the annular protrusion 47 is fit into the annular fitting recess 52. As a result, a load is applied to the annular protrusion 47 and the annular fitting recess 53 in the axial direction DRa or in the intersecting direction intersecting the axial direction DRa when the motor holder 50 is connected to the fan casing 40. In this embodiment, the load applied to the annular protrusion 47 and the annular fitting recess 53 when the motor holder 50 is connected to the fan casing 40 is referred to as a contacting load.

The annular protrusion 47 and the annular fitting recess 53 are configured such that the contacting load applied to the first non-attachment portions 452B and the second non-attachment portions 52B is larger than the contacting load applied to the first attachment portions 452A and the second attachment portions 52A when the motor holder 50 is connected to the fan casing 40.

In this embodiment, the annular fitting recess 53 includes depths Ld in the axial direction DRa that are different in the circumferential direction such that the contacting load applied to the second non-attachment portions 52B is greater than the contacting load applied to the second attachment portions 52A.

As shown in FIGS. 5 and 7, the annular fitting recess 52 includes depths Ld2 at parts located in the second non-attachment portions 52B that are less than depths Ld1 at parts located in the second attachment portions 52A in a state where the motor holder 50 is detached from the fan casing 40. In addition, the parts located in the second non-attachment portions 52B have a distance Lih2 between a bottom of the annular fitting recess 53 and the facing end surface 542 of the holder flange 54. The parts located in the second attachment portions 52A have a distance Lih1 between the bottom of the annular fitting recess 53 and the facing end surfaces 542. The distance Lih2 is larger than the distance Lih1. The depths Ld2 of the parts of the annular fitting recess 52 located in the second non-attachment portions 52B are the same with each other.

The motor holder 50 and the duct 60 are integrally formed by injection molding. If it is difficult to integrally mold the motor holder 50 and the duct 60 as a whole, a part of the motor holder 50 and the duct 60 may be formed as a different member from the integral molding.

Next, an operation of the electric blower 10 will be described. As shown in FIG. 2, when the fan 20 of the electric motor 30 is rotated by the electric motor 30, air is drawn into the fan 20 through the air suction opening 440 of the bell mouth plate 44. The air drawn into the fan 20 is blown out to the ventilation passage 41 located in radially outward of the fan 20. The air flowing through the ventilation passage 41 is blown out through the air blowing outlet 43 of the fan casing 40. At this time, a part of the air flowing through the ventilation passage 41 flows into the duct receiving portion 46 through the communication hole 451a. The air flowing into the duct receiving portion 46 is guided to an inside of the motor housing 51 through the cooling air passage 61 in the duct 60. As a result, the electric motor 30 is cooled.

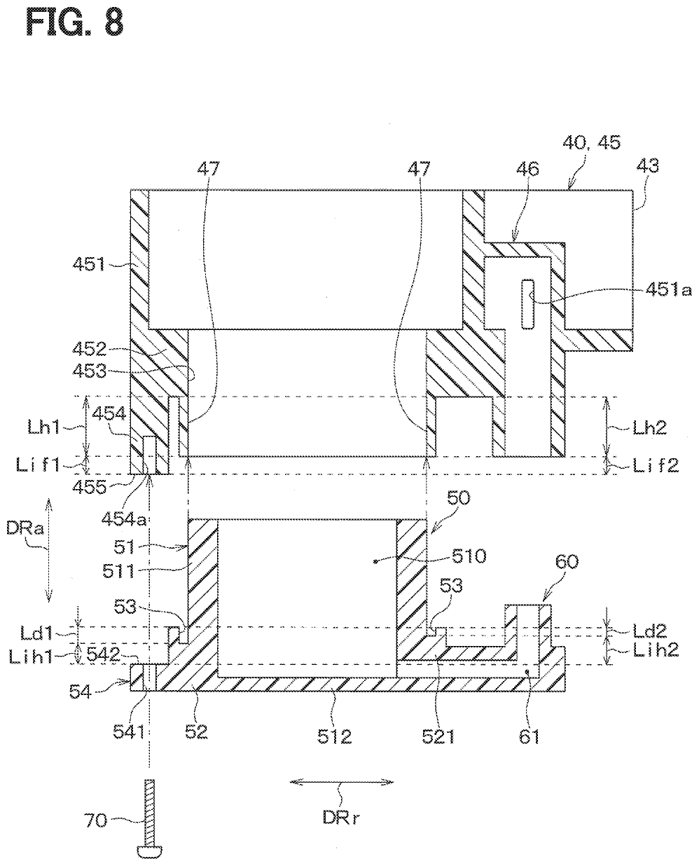

Next, a connecting method between the fan casing 40 and the motor holder 50 will be described with reference to FIG. 8. At first, the motor housing 51 of the motor holder 50 is inserted into the insertion hole 453 of the fan casing 40. Then, the annular protrusion 47 of the fan casing 40 is fit into the annular fitting recess 53 of the motor holder 50. In this time, since the depths Ld2 of the parts of the annular fitting recess 53 located in the second non-attachment portions 52B are smaller than the depths Ld1, the parts of the annular protrusion 47 located in the first non-attachment portions 452B are in contact with the bottom surfaces of the parts of the annular fitting recess 53 located in the second non-attachment portions 52B.

In this state, the fastening bolts 70 are inserted into the bolt insertion holes 541 and the attachment holes 454a and the fastening bolts 70 are engaged with the thread of the attachment holes 454a, so that the motor holder 50 is connected to the fan casing 40. At this time, the parts of the annular protrusion 47 located in the first non-attachment portions 452B or the parts of the annular fitting recess 53 located in the second non-attachment portions 52B are compressed. Thus, the contacting load applied to the parts of the annular protrusion 47 located in the first non-attachment portions 452B and the parts of the annular fitting recess 53 located in the second non-attachment portions 52B increases.

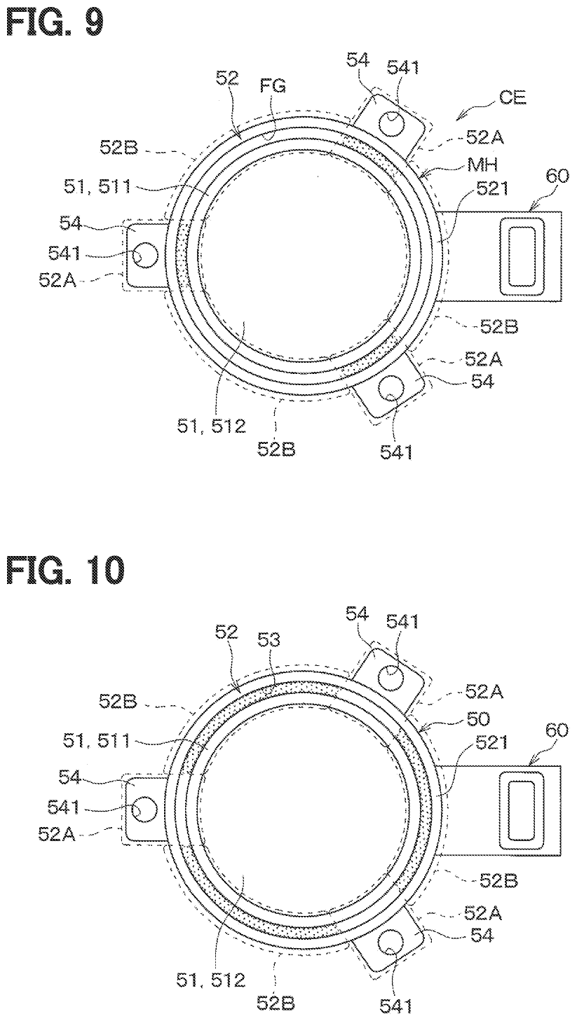

FIG. 9 is a schematic view of a motor holder MH of an electric blower CE in a comparative example. In the electric blower CE in the comparative example, an annular fitting recess FG of the motor holder MH has a constant depth Ld, which is different from the present embodiment. For description purposes, the same reference numerals are assigned to common elements between the motor holder MH in the comparative example and the motor holder 50 in the present embodiment. In FIG. 9, hatched portions in a dot pattern shows a region of the annular protrusion 47 and the annular fitting recess FG to which large amount of the contacting load is applied when the motor holder MH is connected to the fan casing 40.

As shown in FIG. 9, the parts of the annular protrusion 47 and the annular fitting recess FG located in the second attachment portions 52A receive the contacting load that is greater than the contacting load applied to the parts of the annular protrusion 47 and the annular fitting recess FG located in the second non-attachment portions 52B. That is, in the electric blower CE in the comparative example, the contacting load applied to the annular protrusion 47 and the annular fitting recess FG is concentrated on the first attachment portions 452A and the second attachment portions 52A.

Thus, when vibrations of the electric motor 30 are transmitted to the fan casing 40 through the motor holder 50, the first non-attachment portions 452B and the second non-attachment portions 52B largely vibrate using the first attachment portions 452A and the second attachment portions 52A as nodes.

In contrast, FIG. 10 is a schematic view of the motor holder 50 of the electric blower 10 in this embodiment. In FIG. 10, hatched portions in a dot pattern shows a region of the annular protrusion 47 and the annular fitting recess 53 to which large amount of the contacting load is applied when the motor holder 50 is connected to the fan casing 40.

As shown in FIG. 10, in the electric blower 10 of this embodiment, the parts of the annular protrusion 47 and the annular fitting recess 53 located in the second non-attachment portions 52B receive the contacting load that is greater than the contacting load applied to the parts of the annular protrusion 47 and the annular fitting recess 53 located in the second attachment portions 52A. That is, in the electric blower 10 in this embodiment, the contacting load applied to the parts of the annular protrusion 47 and the annular fitting recess 53 located in the first non-attachment portions 452B and the second non-attachment portions 52B are larger than the contacting load applied to the parts located in the first attachment portions 452A and the second attachment portions 52A.

Thus, the parts of the annular protrusion 47 and the annular fitting recess 53 located in the first non-attachment portions 452B and the second non-attachment portions 52B are more likely to keep in contact with each other even when the electric motor 30 is operated. Therefore, the first non-attachment portions 452B and the second non-attachment portions 52B are restricted from vibrating.

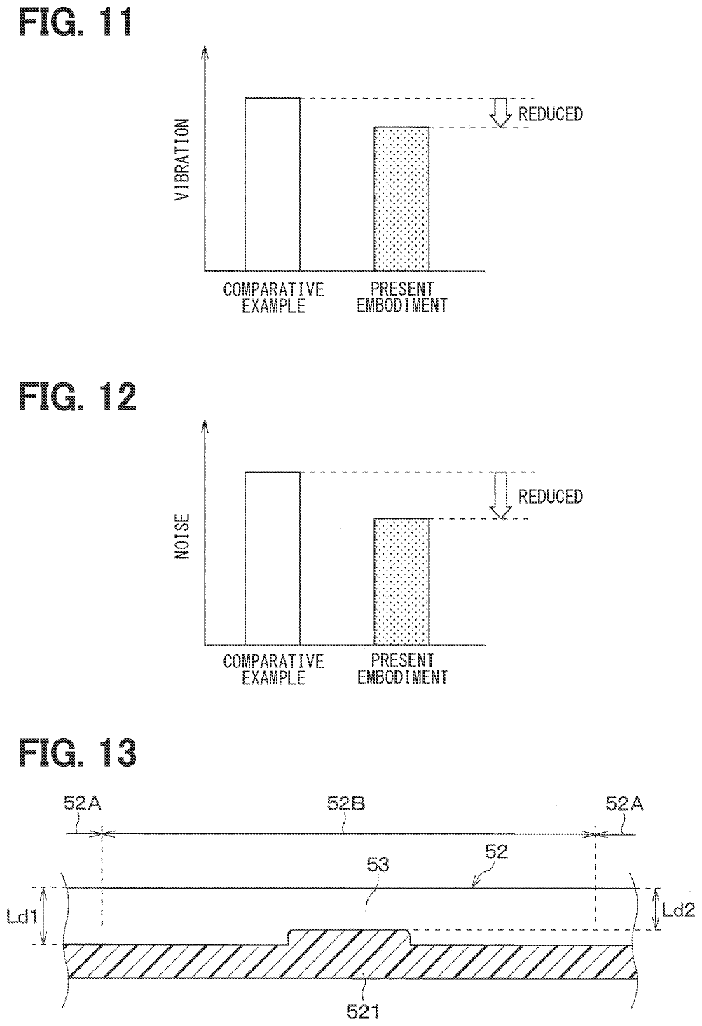

FIGS. 11 and 12 are graphs illustrating measurement results of vibrations and noises generated in the electric blower 10 of the present embodiment and the electric blower CE of the comparative example. As shown in FIGS. 11 and 12, the electric blower 10 of this embodiment can reduce both vibrations and noises compared to the electric blower CE of the comparative example.

The electric blower 10 in this embodiment described above is configured such that the contacting load applied to the parts of the annular protrusion 47 and the annular fitting recess 53 located in the first non-attachment portions 452B and the second non-attachment portions 52B increases. Since the noises caused by vibrations of the first non-attachment portions 452B and the second non-attachment portions 52B are reduced with this configuration, noises of the electric blower 10 can be reduced.

In this embodiment, the contacting load applied to the parts of the annular protrusion 47 and the annular fitting recess 53 located in the first non-attachment portions 452B and the second non-attachment portions 52B is increased by adjusting the depths Ld of the annular fitting recess 53 in the circumferential direction. Thus, the noises of the electric blower 10 can be reduced with a simple structure.

In addition, in a configuration in which the fan casing 40 is connected to the motor holder 50 by the annular protrusion 47 and the annular fitting recess 53, the connecting portion between the fan casing 40 and the motor holder 50 forms a labyrinth configuration. Thus, air leakage and water intrusion through the connecting portion between the fan casing 40 and the motor holder 50 can be restricted.

### Modification of First Embodiment

In the first embodiment described above, the annular protrusion 47 has a constant height Lh in the circumferential direction, but the present disclosure is not limited to this. The parts of the annular protrusion 47 located in the first attachment portions 452A may have heights that is different from heights of the parts of the annular protrusion 47 located in the first non-attachment portions 452B while a distance Lif between the attachment end surfaces 455 of the supporters 454 serving as mating surfaces and the tip end of the annular protrusion 47 is constant.

In the first embodiment described above, the annular fitting recess 53 has depths Ld1 at the parts located in the second attachment portions 52A and depths LD2 at the parts located in the second non-attachment portions 52B. The depths Ld1 are less than the depths Ld2, but the present disclosure is not limited to this. The depths Ld1 in the second attachment portion 52A may be the same as the depths Ld2 in the second non-attachment portions 52B while the distance Lih2 in the second non-attachment portions 52B between the facing end surfaces 542 of the holder flanges 54 and the bottom surface of the annular fitting recess 53 is larger than the distance Lih1 in the second attachment portions 52A.

In the first embodiment described above, the entire of each of the parts of the annular fitting recess 53 located in the second non-attachment portions 52B have depths that is less than the depths Ld1 of each of the parts located in the second attachment portions 52A. However, the present disclosure is not limited to this. As shown in FIG. 13, the annular fitting recess 53 may be configured such that a part of the parts located in the second non-attachment portions 52B may have the depth Ld2 that is less than the depths Ld1 of the parts located in the second attachment portions 52A.

In the first embodiment described above, each of the second non-attachment portions 52Bb of the annular fitting recess 53 has the depth Ld2 that is reduced in size, but the present disclosure is not limited to this. At least one of the second non-attachment portions 52B of the annular fitting recess 53 has the depth Ld2 that is reduced in size.

When the duct 60 extending outward in the intersecting direction is connected to a portion of the extending portion 52 that is outside of the second attachment portion 52A, the duct 60 has a structure similar to a cantilever. Thus, when the duct connecting portion 521 of the extending portion 52 connected to the duct 60 vibrates, the duct 60 largely vibrates. When the large vibrations generated in the duct 60 are transmitted to the fan casing 40, the noises become more remarkable.

Thus, it is preferable that the electric blower 10 is configured such that at least a part of the annular protrusion 47 and the annular fitting recess 53 located in the duct connecting portion 521 of the second non-attachment portions 52B receive the contacting load that is greater than the contacting load applied to the parts of the annular protrusion 47 and the annular fitting recess 53 located in the second attachment portions 52. The same also applies to the following embodiments.

With this configuration, the contacting state between the annular protrusion 47 and the annular fitting recess 53 is likely to be kept in the duct connecting portion 521 even when the electric motor 30 is operated. In addition, the duct 60 is supported by the motor holder 50 at a supporting point and a portion of the duct 60 located outside of the supporting point is shortened. That is, a length of the cantilevered portion of the duct 60 is shortened. As a result, the duct connecting portion 521 and the duct 60 connected to the duct connecting portion 521 are restricted from vibrating, so that the noises caused by the vibrations of the duct 60 are sufficiently suppressed.

### Second Embodiment

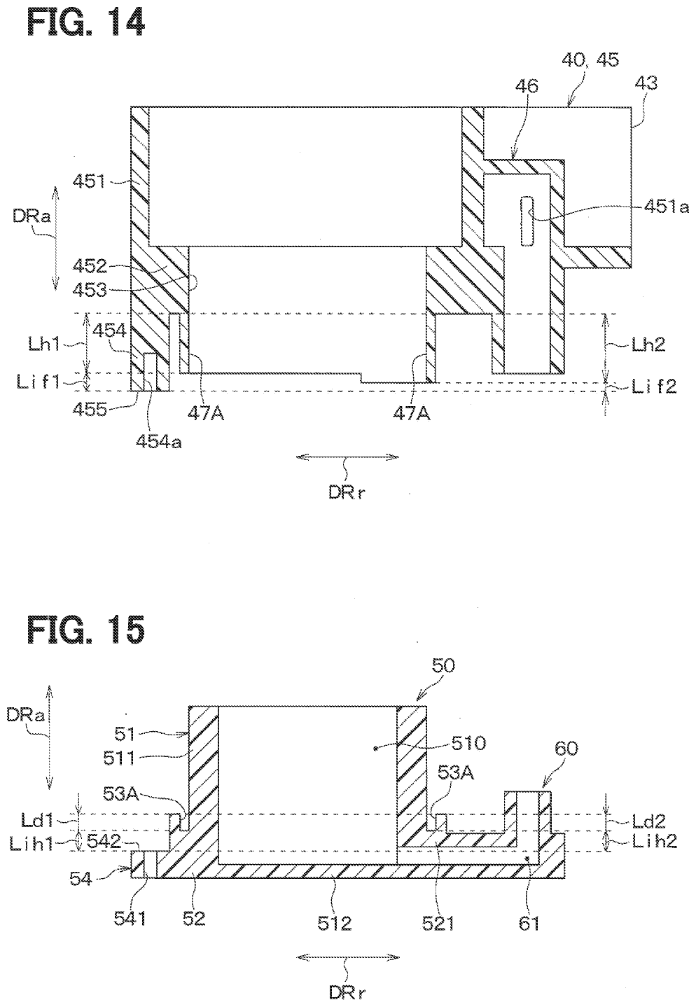

Next, a second embodiment will be described with reference to FIGS. 14 to 16. The second embodiment is different from the first embodiment at a point that heights Lh of the parts of an annular protrusion 47A differ in the circumferential direction. In this embodiment, different portions from the first embodiment will be mainly described and descriptions of similar portions to the first embodiment will be omitted.

As shown in FIG. 14, the annular protrusion 47A has the heights Lh in the axial direction DRa that differ in the circumferential direction such that the first non-attachment portions 452B receive the contacting load that is greater than the contacting load applied to the first attachment portions 452A.

Specifically, the first attachment portions 452A have the heights Lh1 and the first non-attachments portion 452B have the heights Lh2. The heights Lh2 are larger than the heights Lh1 in a state where the motor holder 50 is detached from the fan casing 40. The parts of the annular protrusion 47A located in the first non-attachment portions 452B has a distance Lif2 between a tip end of the annular protrusion 47A and the attachment end surfaces 455 and the parts of the annular protrusion 47A located in the first attachment portions 452A has a distance Lif1 between a tip end of the annular protrusion 47A and the attachment end surfaces 455. The distance Lif2 is less than the distance Lif1. The annular protrusion 47A is configured such that the heights Lh2 of the parts located in the first non-attachment portions 452B are the same with each other.

In contrast, as shown in FIG. 15, an annular fitting recess 53A is configured such that the depth Ld in the axial direction is constant in the circumferential direction. That is, the annular fitting recess 53A in this embodiment has the depths Ld1 at the parts located in the second attachment portions 52A that is the same with the depths Ld2 at the parts located in the second non-attachment portions 52B.

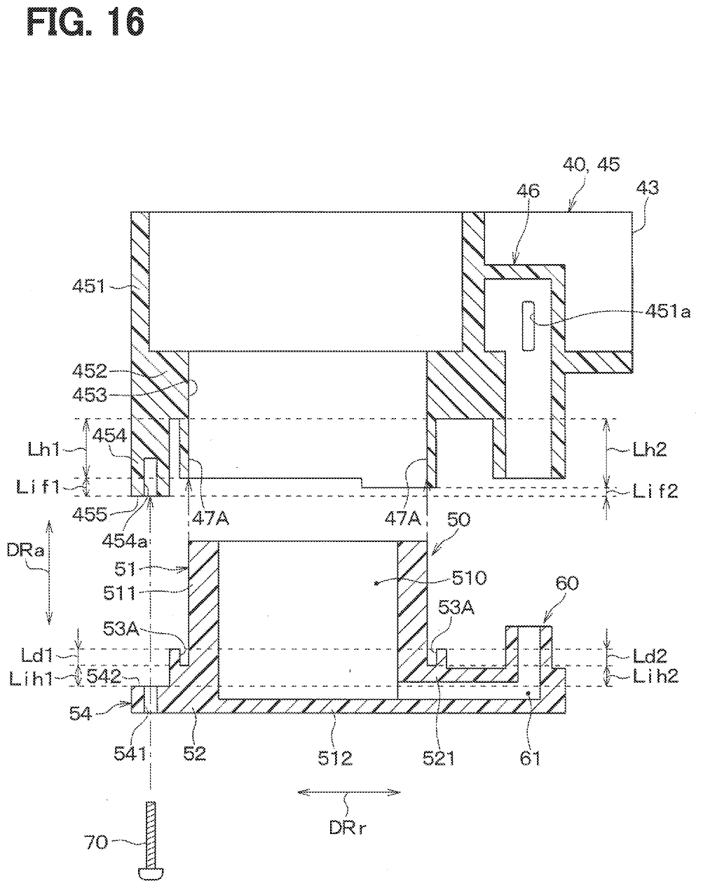

Other configurations are similar to the first embodiment. As shown in FIG. 16, in the electric blower 10 in this embodiment, the motor housing 51 of the motor holder 50 is inserted into the insertion hole 453 of the fan casing 40. The annular protrusion 47A of the fan casing 40 is fit into the annular fitting recess 53A of the motor holder 50. At this time, since the heights Lf2 of the parts of the annular protrusion 47A located in the first non-attachment portions 452B are larger than the heights Lf2 of the parts located in the first attachment portions 452A, the parts of the annular protrusion 47A located in the first non-attachment portions 452B are in contact with a bottom surface of the annular fitting recess 53A.

In this state, the fastening bolts 70 are inserted into the bolt insertion holes 541 and the attachment holes 454a and the fastening bolts 70 are engaged with the thread of the attachment holes 454a, so that the motor holder 50 is connected to the fan casing 40. At this time, the parts of the annular protrusion 47A located in the first non-attachment portions 452B or the parts of the annular fitting recess 53A located in the second non-attachment portions 52B are compressed. Thereby, the contacting load applied to the parts of the annular protrusion 47A located in the first non-attachment portions 452B and the parts of the annular fitting recess 53A located in the second non-attachment portion 52B is increased.

The electric blower 10 in this embodiment described above has a configuration in which the contacting load applied to the parts of the annular protrusion 47A located in the first non-attachment portions 452B and the parts of the annular fitting recess 53A located in the second non-attachment portions 52B is increased as with the first embodiment. Since the noises caused by the vibrations of the first non-attachment portions 452B and the second non-attachment portions 52B are reduced, noises in the electric blower 10 can be reduced.

In particular in this embodiment, the contacting load applied to the parts of the annular protrusion 47 located in the first non-attachment portions 452B and the parts of the annular fitting recess 53 located in the second non-attachment portions 52B is increased by adjusting the heights of the annular protrusion 47A in the circumferential direction. Thus, the noises of the electric blower 10 can be reduced with a simple structure.

### Modification of the Second Embodiment

In the second embodiment described above, an entire of the parts of the annular protrusion 47A located in the first non-attachment portions 452B have the heights Lh2 that are larger than the heights Lh1 of the parts located in the first attachment portions 452A. However, the present disclosure is not limited to this. The annular protrusion 47A may be configured such that at least one of the parts located in the first non-attachment portions 452B has the height Lh2 that is larger than the heights Lh1 of each of the parts located in the first attachment portions 452A.

In the second embodiment described above, the annular protrusion 47A has the heights Lh2 at the parts located in the first non-attachment portions 452B that is larger than the heights Lh1 at the parts located in the first attachment portions 452A. However, the present disclosure is not limited to this. The heights Lh1 in the first attachment portions 452A may be the same as the heights Lh2 in the first non-attachment portions 452B while the distance Lif2 in the first non-attachment portions 452B between the attachment end surfaces 455 and the tip end of the annular protrusion 47A is smaller than the distance Lif1 in the first attachment portions 452A.

In the second embodiment described above, the annular fitting recess 53A is described such that the depths Ld2 are the same with each other in the circumferential direction, but the present disclosure is not limited to this. The annular fitting recess 53A may have different depths Ld between the second attachment portions 52A and the second non-attachment portions 52B while the distance Lih between the facing end surfaces 542 and the bottom surface of the annular fitting recess 53A is constant in the circumferential direction.

The annular fitting recess 53A may be configured such that the depths Ld2 of the parts located in the second non-attachment portions 52B are less than the depths Ld1 of the parts located in the second attachment portions 52A as with the first embodiment. This structure also achieves a configuration in which the contacting load applied to the parts of the annular protrusion 47A located in the first non-attachment portions 452B and the parts of the annular fitting recess 53A located in the second non-attachment portions 52B is increased.

### Third Embodiment

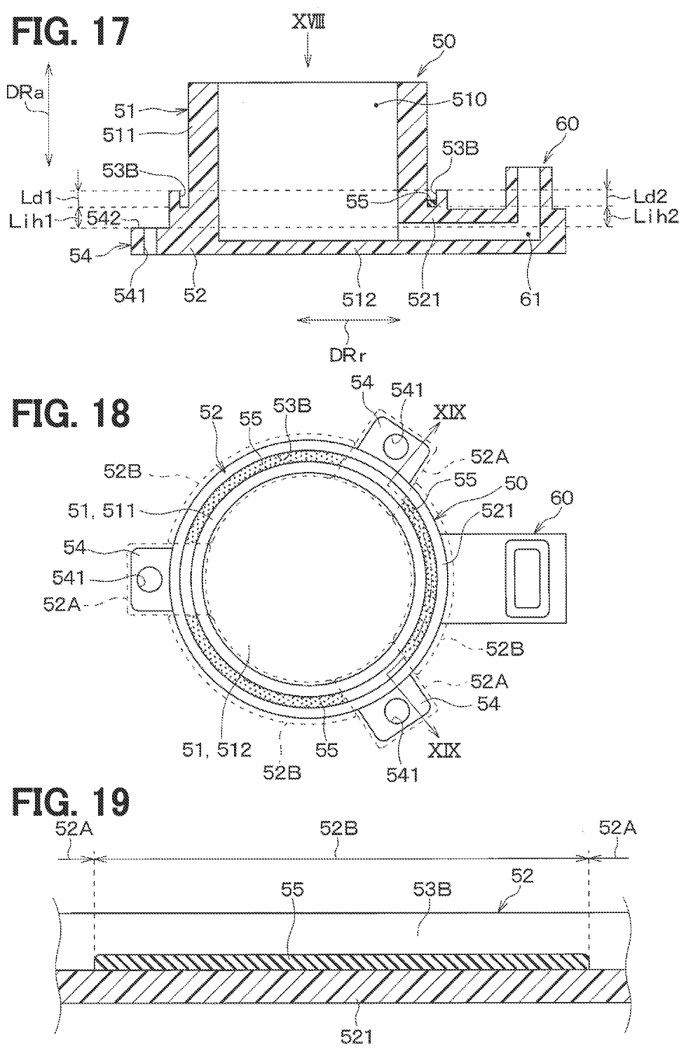

Next, a third embodiment will be described with reference to FIGS. 17 to 20. The third embodiment is different from the first embodiment at a point that elastic bodies 55 that are configured to be elastically deformable are disposed in the parts of an annular fitting recess 53B located in the second non-attachment portions 52B. In this embodiment, different portions from the first embodiment will be mainly described and description of similar portions to the first embodiment will be omitted.

As shown in FIG. 18, the annular fitting recess 53B is configured to have a depth Ld in the axial direction DRa that is constant in the circumferential direction. That is, the annular fitting recess 53B in this embodiment is configured such that the depths Ld1 of the parts located in the second attachment portions 52A are the same as the depths Ld2 of the parts in the second non-attachment portions 52B.

As shown in FIGS. 18 and 19, the elastic bodies 55 that are elastically deformable are disposed in the parts of the annular fitting recess 53B located in the second non-attachment portions 52B. The elastic bodies 55 may be made of a rubber such as ethylene propylene diene monomer rubber (i.e., EPDM).

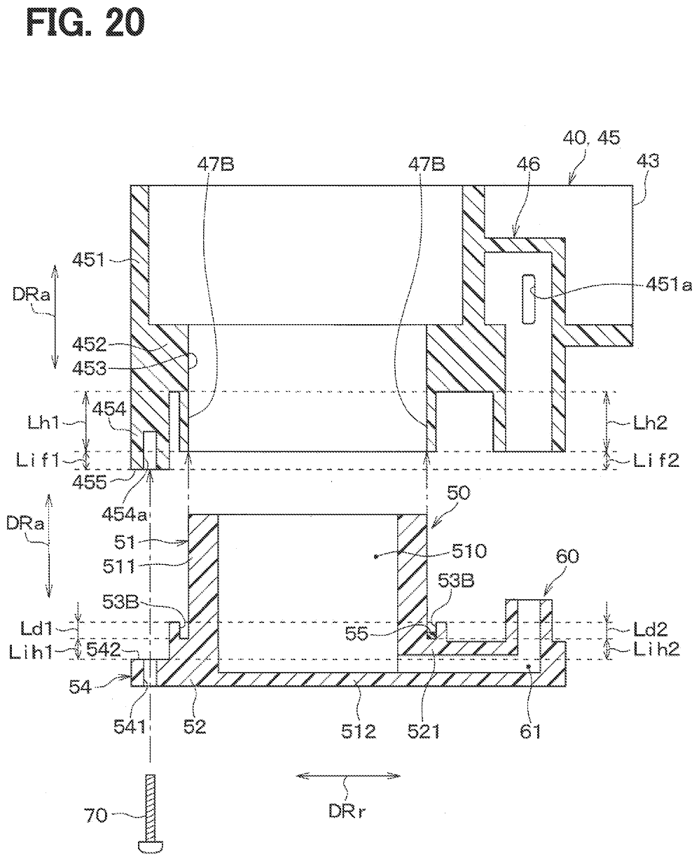

Other configurations are similar to the first embodiment. As shown in FIG. 20, in the electric blower 10 in this embodiment, the motor housing 51 of the motor holder 50 is inserted into the insertion hole 453 of the fan casing 40. The annular protrusion 47B of the fan casing 40 is fit into the annular fitting recess 53B. At this time, since the elastic bodies 55 are disposed in the second non-attachment portions 52B of the annular fitting recess 53B, the parts of the annular protrusion 47B located in the first non-attachment portions 452B are in contact with the elastic bodies 55.

In this state, the fastening bolts 70 are inserted into the bolt insertion holes 541 and the attachment holes 454a and the fastening bolts 70 are engaged with the thread of the attachment holes 454a, so that the motor holder 50 is connected to the fan casing 40. At this time, the elastic bodies 55 disposed between the annular protrusion 47B and the annular fitting recess 53B are compressed and elastically deformed. Thereby, the contacting load applied to the parts of the annular protrusion 47B located in the first non-attachment portions 452B and the parts of the annular fitting recess 53B located in the second non-attachment portions 52B is increased.

The electric blower 10 in the third embodiment described above has a configuration such that the contacting load applied to the parts of the annular protrusion 47B located in the first non-attachment portions 452B and the parts of the annular fitting recess 53B located in the second non-attachment portions 52B is increased as with the first embodiment. Since the noises caused by the vibrations of the first non-attachment portions 452B and the second non-attachment portions 52B are reduced, the noises generated in the electric blower 10 can be reduced.

In particular, in this embodiment, the contacting load applied to the first non-attachment portions 452B and the second non-attachment portions 52B is increased by disposing the elastic bodies 55 between the annular protrusion 47B and the annular fitting recess 53B. Thus, the noises generated in the electric blower 10 are reduced with a simple structure.

### Modification of the Third Embodiment

In the third embodiment described above, the elastic bodies 55 that are elastically deformable are disposed in an entire parts of the annular fitting recess 53B located in the second non-attachment portions 52B, but the present disclosure is not limited to this. At least one of the parts of the annular fitting recess 53B located in the second non-attachment portions 52B may include the elastic body.

In the third embodiment described above, the elastic bodies 55 are added to a structure in which each of the height Lh of the annular protrusion 47 and the depth Ld of the annular fitting recess 53B is constant in the circumferential direction, but the present disclosure is not limited to this. The elastic bodies 55 may be added to the electric blower 10 in which the height Lh of the annular protrusion 47 and/or the depth Ld of the annular fitting recess 53B changes in the circumferential direction.

### Fourth Embodiment

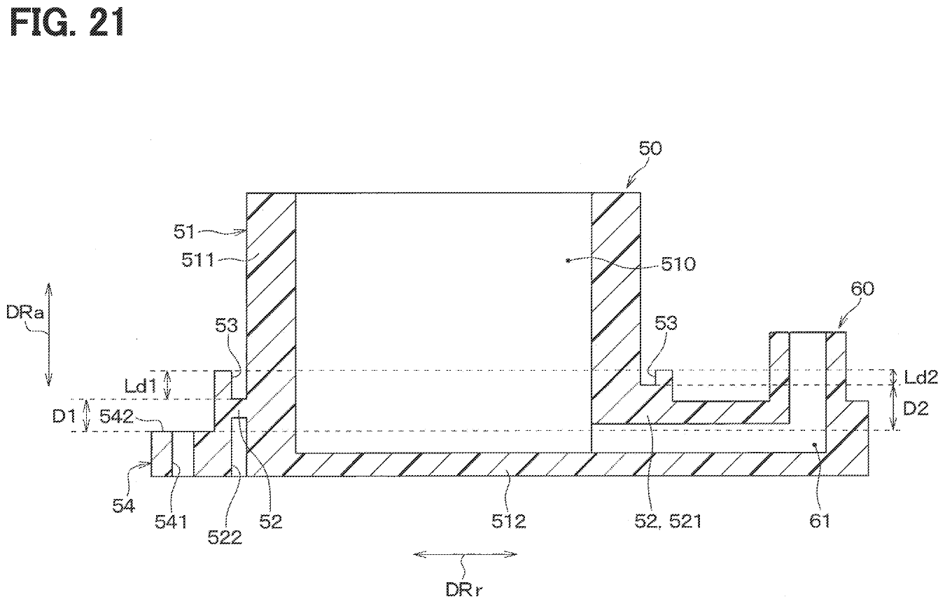

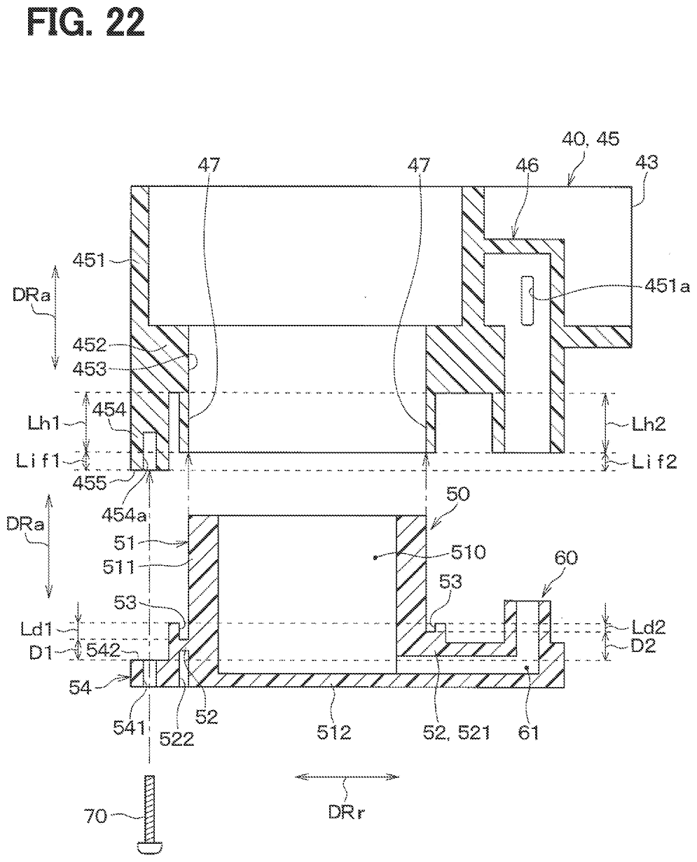

Next, a fourth embodiment will be described with reference to FIGS. 21 and 22. The fourth embodiment is different from the first embodiment at a point that the parts of the extending portion 52 located in the second non-attachment portions 52B have rigidities that are larger than a rigidity of each of the parts of the extending portion 52 located in the second attachment portion 52A. In this embodiment, different portions from the first embodiment are mainly described and descriptions of similar portions to the first embodiment will be omitted.

As shown in FIG. 21, the extending portion 52 in this embodiment includes recesses 522 extending in the axial direction DRa at parts located in the multiple second attachment portions 52A. Specifically, the recesses 522 are located in sides of the extending portion 52 opposite in the axial direction DRa to parts of the annular fitting recess 53 located in the second attachment portions 52A.

The multiple second attachment portions 52A are thinned by defining the recess 522. That is, a thickness D2 in the axial direction DRa of each of the parts of the extending portion 52 located in the second non-attachment portions 52B is larger than a thickness D1 in the axial direction DRa of each of the parts of the extending portion 52 located in the multiple second attachment portions 52A. Thereby, the rigidities of the parts located in the second non-attachment portions 52B are larger than the rigidity of each of the parts located in the second attachment portions 52A.

Other configurations are similar to the first embodiment. As shown in FIG. 22, in the electric blower 10 in this embodiment, the motor housing 51 of the motor holder 50 is inserted into the insertion hole 453 of the fan casing 40 and the annular protrusion 47 of the fan casing 40 is fit into the annular fitting recess 53.

In this state, the fastening bolts 70 are inserted into the bolt insertion holes 541 and the attachment holes 454a to be engaged with the thread of the attachment holes 454a of the fastening bolts 70, so that the motor holder 50 is connected to the fan casing 40. At this time, the contacting load applied to the parts of the annular protrusion 47 located in the first non-attachment portions 452B and the parts of the annular fitting recess 53 located in the second non-attachment portion 52B becomes large. Since the rigidities of the parts located in the second non-attachment portions 52B are increased, a vicinity of the annular protrusion 47 and the annular fitting recess 53 is restricted from bending.

The electric blower 10 in this embodiment includes the common configuration with the first embodiment. Thus, advantages obtained by the common configuration can be obtained as with the first embodiment.

When the rigidities of the parts located in the first non-attachment portions 452B and the second non-attachment portions 52B are small, the vicinity of the annular protrusion 47 and the annular fitting recess 53 bends when the motor holder 50 is connected to the fan casing 40. As a result, the contacting load applied to the annular protrusion 47 and the annular fitting recess 53 is reduced.

In contrast, the electric blower 10 in this embodiment increases the rigidities at the parts located in the second non-attachment portions 52B. Thus, the vicinity of the annular protrusion 47 and the annular fitting recess 53 is restricted from bending. Thus, the contacting load applied to the parts of the annular protrusion 47 located in the first non-attachment portions 452B and the parts of the annular fitting recess 53 located in the second non-attachment portions 52B is sufficiently restricted from decreasing when the motor holder 50 is connected to the fan casing 40.

### Modification of Fourth Embodiment

In the fourth embodiment described above, the rigidities of the parts of the extending portion 52 located in the second non-attachment portions 52B are set to be larger than the rigidity of each of the parts of the extending portion 52 located in the second attachment portions 52A by defining the recesses 522 at predetermined positions of the extending portion 52. However, the present disclosure is not limited to this. The bottom wall 452 may have a part located in the first attachment portions 452A that has a thinner thickness such that parts of the bottom wall 452 located in the first non-attachment portions 452B have rigidities that are larger than that of each of the parts located in the first attachment portions 452A.

The electric blower 10 may increase rigidities of the parts located in the first non-attachment portions 452B or the second non-attachment portions 52B by increasing thicknesses of the first non-attachment portions 452B or the second non-attachment portions 52B.

### Fifth Embodiment

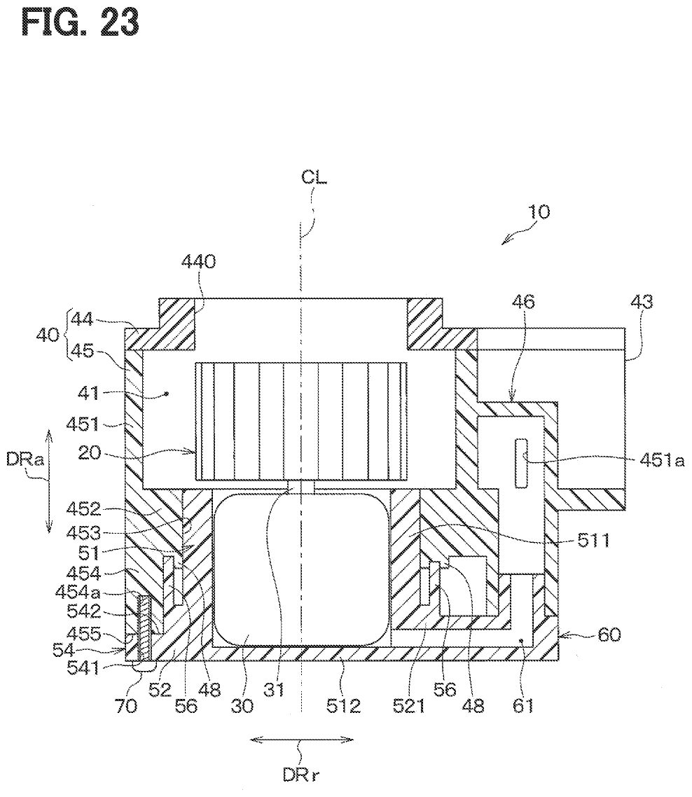

Next, a fifth embodiment will be described with reference to FIGS. 23 to 26. The fifth embodiment is different from the first embodiment at a point that the extending portion 52 includes an annular protrusion 56 and the bottom wall 452 includes an annular fitting recess 48. In this embodiment, different portions from the first embodiment will be mainly described and descriptions of similar portions to the first embodiment will be omitted.

As shown in FIG. 23, the bottom wall 452 in this embodiment includes the annular fitting recess 48 having an annular shape in a circumferential edge of the bottom wall 452 that defines the insertion hole 453. That is, the bottom wall 452 includes the annular fitting recess 48 in place of the annular protrusion 47 in the first embodiment. The annular fitting recess 48 is integrally formed with the bottom wall 452.

The extending portion 52 in this embodiment includes the annular protrusion 56 having an annular shape and fitting into the annular fitting recess 48 when the motor holder 50 is connected to the fan casing 40. That is, the extending portion 52 includes the annular protrusion 56 in place of the annular fitting recess 53 in the first embodiment. The annular protrusion 56 is integrally formed with the extending portion 52.

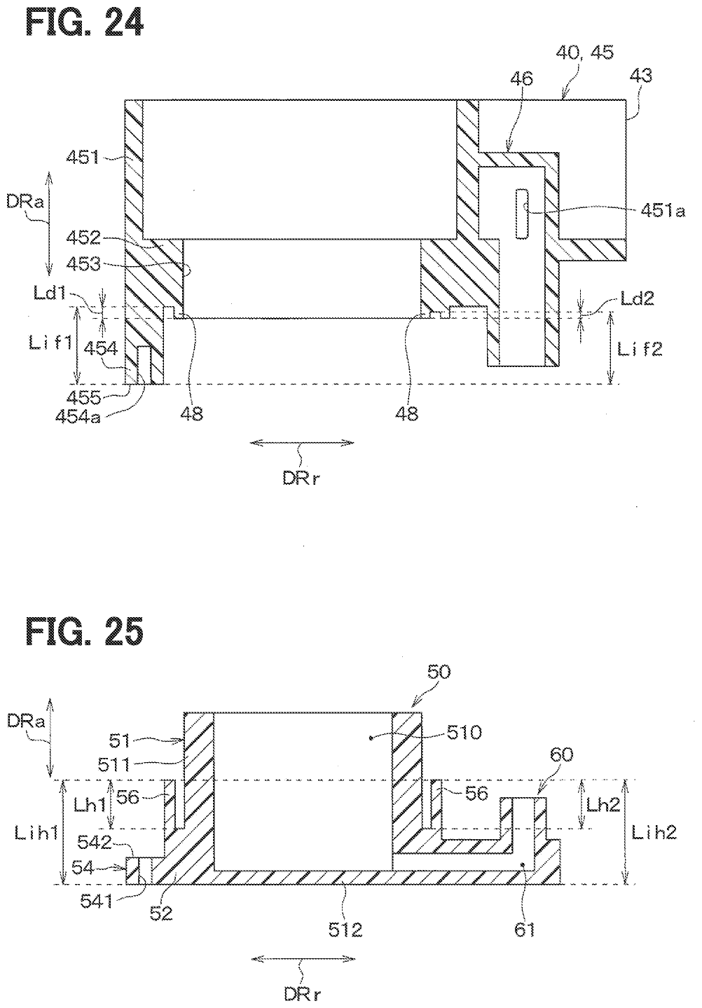

Specifically, as shown in FIG. 24, the depths Ld2 of the parts of the annular fitting recess 48 located in the first non-attachment portions 452B are less than the depth Ld1 of each of the parts of the annular fitting recess 48 located in the first attachment portions 452A in a state where the motor holder 50 is detached from the fan casing 40. Additionally, a distance Lif2 in the first non-attachment portions 452 between the attachment end surfaces 455 and bottom surfaces of the annular fitting recess 48 is less than a distance Lif1 in the first attachment portions 452A between the attachment end surfaces 455 and bottom surfaces of the annular fitting recess 48. The annular fitting recess 48 includes depths Ld2 that are constant in the entire parts located in the first non-attachment portions 452B.

As shown in FIG. 25, the annular protrusion 56 protrudes toward the bottom wall 452 of the fan casing 40. The annular protrusion 56 has a height Lh in the axial direction DRa that is constant in the circumferential direction. That is, the annular protrusion 56 in this embodiment is configured such that heights Lh1 of the parts located in the second attachment portions 52A are the same as the heights Lh2 of the parts located in the second non-attachment portions 52B.

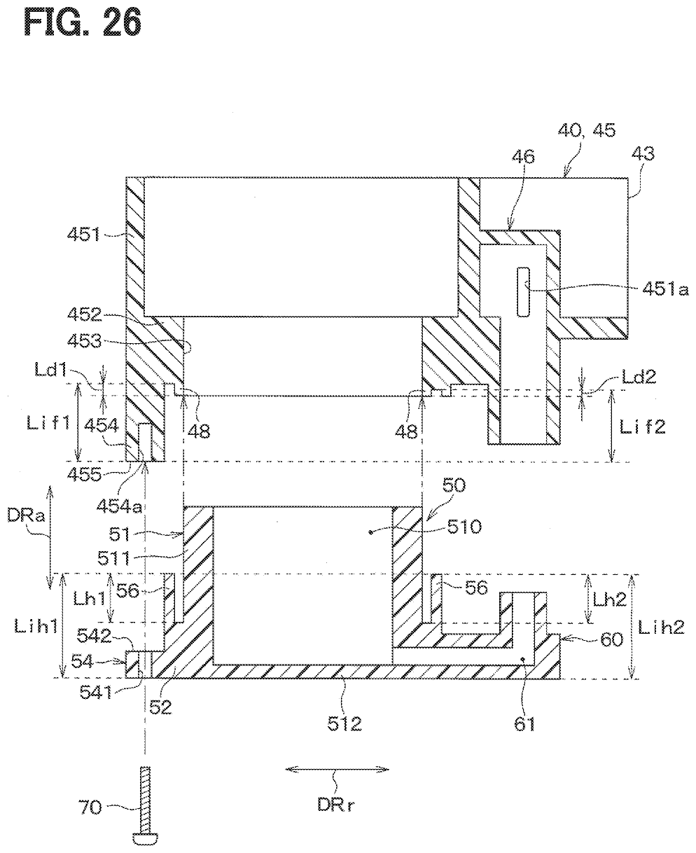

As shown in FIG. 26, in the electric blower 10 configured as described above, the motor housing 51 of the motor holder 50 is inserted into the insertion hole 453 of the fan casing 40 and the annular protrusion 47 of the fan casing 40 is fit into the annular fitting recess 53. At this time, since the depths Ld2 of the parts of the annular fitting recess 48 located in the first non-attachment portions 452B are smaller than the depths Ld1, the parts of the annular protrusion 56 located in the second non-attachment portions 52B are in contact with the bottom surface of the annular fitting recess 48.

In this state, the fastening bolts 70 are inserted into the bolt insertion holes 541 and the attachment holes 454a to be engaged with the thread of the attachment holes 454a, so that the motor holder 50 is connected to the fan casing 40. At this time, the parts of the annular protrusion 56 located in the second non-attachment portions 52B or the parts of the annular fitting recess 48 located in the first non-attachment portions 452B are compressed. As a result, the contacting load applied to the parts of the annular protrusion 56 located in the first non-attachment portions 452B and the parts of the annular fitting recess 48 located in the second non-attachment portions 52B is increased.

The electric blower 10 in this embodiment described above includes a configuration in which the contacting load applied to the parts of the annular protrusion 56 located in the first non-attachment portions 452B and the parts of the annular fitting recess 48 located in the second non-attachment portions 52Bb is increased as with the first embodiment. Thus, the noises caused by vibrations of the first non-attachment portions 452B and the second non-attachment portions 52B are reduced and noises of the electric blower 10 can be also reduced.

### Modification of the Fifth Embodiment

In the above described fifth embodiment, the height Lh of the annular protrusion 56 is constant in the circumferential direction, but the present disclosure is not limited to this. The annular protrusion 56 may have different heights Lh between the second attachment portions 52A and the second non-attachment portions 52B while the distance Lih between the facing end surfaces 542 serving as a mating surface and the tip end of the annular protrusion 56 is constant in the circumferential direction.

In the fifth embodiment described above, the annular fitting recess 48 is described such that the depths Ld2 of the parts located in the first non-attachment portions 452B are less than the depths Ld1 of the parts located in the first attachment portions 452A. However, the present disclosure is not limited to this. The depths Ld1 of the first attachment portions 452A may be the same with the depths Ld2 of the first non-attachment portions 452B while the distance Lif2 in the first non-attachment portions 452B between the attachment end surfaces 455 and the bottom surface of the annular fitting recess 48 is smaller than the distance Lif1 in the first attachment portions 452A.

In the fifth embodiment described above, each of the parts of the annular fitting recess 48 located in the multiple non-attachment portions 52B has the depth Ld2 that is smaller than the depths Ld1, but the present disclosure is not limited to this. At least one of the parts of the annular fitting recess 48 located in the multiple non-attachment portions 52B has the depth Ld2 that is smaller than the depth Ld1 of each of the parts located in the attachment portions 52A.

In the fifth embodiment described above, the annular protrusion 56 has the height Lh that is constant in the circumferential direction and the annular fitting recess 48 has the depths Ld that is set to be smaller at the parts located in the second non-attachment portions 52B, but the present disclosure is not limited to this. The electric blower 10 may be configured such that the depth Ld of the annular fitting recess 48 is constant in the circumferential direction and the heights Lh of the annular protrusion 56 is set to be large at the parts located in the first non-attachment portions 452B similarly to the second embodiment. The electric blower 10 may be configured such that the depths Ld of the annular fitting recess 48 are set to be small at the parts located in the second non-attachment portions 52B and the heights Lh of the annular protrusion 56 is set to be large at the parts located in the first non-attachment portions 452B. A configuration in which the contacting load applied to the parts of the annular protrusion 47 located in the first non-attachment portions 452B and the parts of the annular fitting recess 53 located in the second non-attachment portion 52B is increased can be also achieved.

### Other Embodiments

Although representative embodiments of the present disclosure have been described above, the present disclosure is not limited to the embodiments described above, and various modifications can be made, for example, as follows.

In the above embodiments, the number of the attachment portions to attach the motor holder 50 to the fan casing 40 is three, but the present disclosure is not limited to this. The electric blower 10 may have two or more than four attachment portions.

In the above embodiments, the duct 60 is connected to the motor holder 50, but the present disclosure is not limited to this. The electric blower 10 may omit the duct 60 if the electric blower 10 has another cooling structure for the electric motor 30.

In the above embodiments, the fan 20 is constituted as a centrifugal fan, but the present disclosure is not limited to this. The electric blower 10 may be a tilted flow fan.

In the above embodiments, the electric motor 30 is constituted as an inner rotor type brushless motor, but the present disclosure is not limited to this. The electric blower 10 may have an electric motor 30 constituted as an outer rotor type blower motor. The electric motor 30 is not limited to a brushless motor and may be a motor with a brush.

In the above embodiments, the fan casing 40 is constituted as a scroll casing, but the present disclosure is not limited to this. The fan casing 40 may be constituted by a full-circumferential blowing type casing in which entire circumference of a portion facing the fan 20 in the radial direction DRr opens.

In the above embodiments, the electric blower 10 in this disclosure is applied to a blower unit of an air conditioning unit configured to condition an air in a vehicle cabin, but the present disclosure is not limited to this. The electric blower 10 in this disclosure can be widely applied for devices other than the air conditioner.

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component and the like, the present disclosure is not limited to the shape, positional relationship, and the like, except for the case of being specifically specified, the case of being fundamentally limited to a specific shape, positional relationship, and the like, and the like.

### Overview

According to a first aspect of a part or all parts in embodiments described above, an electric blower includes a fan, an electric motor, a motor holder, and a fan casing. The motor holder includes a motor housing having a tubular shape and housing the electric motor and an extending portion having an annular shape, surrounding the motor housing, and overlapping with a facing wall in an axial direction. The extending portion and the facing portion include multiple attachment portions configured to connect the motor holder to the fan casing in a state where the motor housing is inserted into the insertion hole. The multiple attachment portions are arranged in a circumferential direction of the motor housing at predetermined intervals. The extending portion and the facing portion include multiple non-attachment portions between the attachment portions in the circumferential direction. One of the extending portion and the facing portion includes an annular protrusion protruding toward the other one of the extending portion and the facing portion. The other one of the extending portion and the facing portion includes an annular fitting recess into which the annular protrusion is fit when the motor holder is connected to the fan casing. A contacting load is defined by a load applied to the annular protrusion and the annular fitting recess in the axial direction or an intersecting direction intersecting the axial direction in a state where the motor holder is connected to the fan casing by the attachment portions. The annular protrusion and the annular fitting recess are configured such that at least one of the non-attachment portions receives the contacting load that is larger than the contacting load applied to each of the attachment portions.

According to a second aspect, the fan casing of the electric blower defines a ventilation passage through which air blown out by the fan flows. The extending portion includes a duct connecting portion to which a duct is connected at a position outside of the multiple attachment portions. The duct extends outward in the intersecting direction and guides a part of the air flowing through the ventilation passage to flow into the motor housing as a cooling air for the electric motor. The annular protrusion and the annular fitting recess are configured such that the duct connecting portion of the extending portion receives the contacting load that is larger than the contacting load applied to each of the attachment portions.

When the duct that extends outward in the intersecting direction is connected to the duct connecting portion of the extending portion outside of the multiple attachment portions and when the duct connecting portion of the extending portion vibrates, the duct largely vibrates. When the large vibrations generated in the duct are transmitted to the fan casing, noises becomes more remarkable.

In contrast, when the contacting load between the annular protrusion and the annular fitting recess applied to the duct connecting portion of the extending portion connected to the duct is large, the annular protrusion and the annular fitting recess located in the duct connecting portion is likely to keep in contact with each other even in operating the electric motor. As a result, the duct connecting portion and the duct connected to the duct connecting portion are restricted from vibrating, so that the noises caused by the vibrations of the duct can be sufficiently restricted.

According to a third aspect, the annular fitting recess of the electric blower has depths in the axial direction at parts located in the non-attachment portions and depths located in the attachment portions in a state where the motor holder is detached from the fan casing. At least one of the depths in the non-attachment portions are less than each of the depths of the parts located in the attachment portions. Accordingly, the contacting load between the annular protrusion and the annular fitting recess applied to the non-attachment portions can be increased by adjusting depths of the annular fitting recess in the circumferential direction of the motor housing. That is, the noises in the electric blower can be reduced with a simple structure.

According to a fourth embodiment, the annular protrusion of the electric blower has heights in the axial direction at parts located in the non-attachment portions and heights at parts located in the attachment portions in a state where the motor holder is detached from the fan casing. At least one of the heights of the parts located in the non-attachment portions is greater than each of the heights of the parts located in the attachment portions. As a result, the contacting load between the annular protrusion and the annular fitting recess applied to the non-attachment portions can be increased by adjusting the heights of the annular protrusion in the circumferential direction of the motor housing. That is, the noises in the electric blower can be reduced with a simple structure.

According to a fifth embodiment, the annular fitting recess has parts located in the non-attachment portions and parts located in the attachment portions. At least one of the parts located in the non-attachment portions has an elastic body that is configured to be elastically deformable. Thus, the contacting load applied to the non-attachment portions can be increased by disposing the elastic body between the annular protrusion and the annular fitting recess in the non-attachment portions. That is, the noises in the electric blower can be reduced with a simple structure.

According to a sixth embodiment, at least one of the extending portion and the facing portion of the electric blower is configured to have a part located in the non-attachment portions that has a rigidity larger than rigidities of parts located in the attachment portions.

When the rigidity of the part located in the non-attachment portions is small, a vicinity of the annular protrusion and the annular fitting recess may bend by connecting the motor holder to the fan casing, which decreases the contacting load between the annular protrusion and the annular fitting recess in the non-attachment portions.

In contrast, when the rigidity of the part located in the non-contacting portions is large, the vicinity of the annular protrusion and the annular fitting recess is less likely to bend. Thus, the contacting load between the annular protrusion and the annular fitting recess located in the non-attachment portions can be restricted from decreasing when the motor holder is connected to the fan casing with the attachment portions.

What is claimed is:

1. An electric blower configured to blow an air, the electric blower comprising:
a fan configured to generate an airflow by rotating about a rotational axis;
an electric motor configured to rotate the fan;
a motor holder holding the electric motor; and
a fan casing housing the fan and including a facing wall that faces an air suction opening and that defines an insertion hole, an air being introduced into the fan through the air suction opening, a part of the motor holder being inserted into the insertion hole, wherein
the motor holder includes:
a motor housing that has a tubular shape and houses the electric motor; and
an extending portion that has an annular shape, surrounds the motor housing, and overlaps with the facing wall in an axial direction along the rotational axis,
the facing wall and the extending portion include a plurality of attachment portions that connect the motor holder to the fan casing in a state where the motor housing is inserted into the insertion hole, the plurality of attachment portions being arranged in a circumferential direction of the motor housing at predetermined intervals,
the facing wall and the extending portion include a plurality of non-attachment portions between the plurality of attachment portions in the circumferential direction,
either one of the facing portion and the extending portion includes an annular protrusion that protrudes toward the other of the facing portion and the extending portion,
the other of the facing portion and the extending portion includes an annular fitting recess into which the annular protrusion is fit when the motor holder is connected to the fan casing,
a contacting load is defined by a load applied to the annular protrusion and the annular fitting recess in the axial direction or an intersecting direction intersecting the axial direction in a state where the motor holder is connected to the fan casing by the plurality of attachment portions, and
the annular protrusion and the annular fitting recess are configured such that at least one of the plurality of non-attachment portions receives the contacting load that is greater than the contacting load applied to each of the plurality of attachment portions.

2. The electric blower according to claim 1, wherein
the fan casing defines a ventilation passage through which the air blown out by the fan flows,
the extending portion includes a duct connecting portion to which a duct is connected at a position outside of the plurality of attachment portions,
the duct extends outward in the intersecting direction and guides, as a cooling air for the electric motor, a part of the air flowing through the ventilation passage to flow into the motor housing, and
the annular protrusion and the annular fitting recess are configured such that the duct connecting portion of the extending portion receives the contacting load that is greater than the contacting load applied to each of the plurality of attachment portions.

3. The electric blower according to claim 1, wherein
the annular fitting recess has depths in the axial direction at parts located in the plurality of non-attachment portions and depths at parts located in the plurality of attachment portions in a state where the motor holder is detached from the fan casing, and
at least one of the depths of the parts located in the plurality of non-attachment portions is less than the depths of the parts located in the plurality of attachment portions.

4. The electric blower according to claim 1, wherein
the annular protrusion has heights in the axial direction at parts located in the plurality of non-attachment portions and heights at parts located in the plurality of attachment portions in a state where the motor holder is detached from the fan casing, and
at least one of the heights of the parts located in the plurality of non-attachment portions is greater than the heights of the parts located in the plurality of attachment portions.

5. The electric blower according to claim 1, wherein
the annular fitting recess has parts located in the plurality of non-attachment portions and parts located in the plurality of attachment portions, and
at least one of the parts located in the plurality of non-attachment portions has an elastic body configured to be elastically deformable.

6. The electric blower according to claim 1, wherein
at least one of the extending portion and the facing portion has parts located in the plurality of non-attachment portions and parts located in the plurality of attachment portions, and
at least one of the parts located in the non-attachment portions has a rigidity that is greater than that of each of the parts located in the plurality of attachment portions.
